(19) United States
(12) Patent Application Publication
(10) Pub. No.: US 2009/0212127 A1
(43) Pub. Date: Aug. 27, 2009

(54) FUEL INJECTOR WITH SINGLE CRYSTAL PIEZOELECTRIC ACTUATOR STACK

(75) Inventors: PAUL REYNOLDS, MOUNTAIN VIEW, CA (US); ROBERT A. BANKS, MOUNTAIN VIEW, CA (US)

Correspondence Address: LAW OFFICE OF KENNETH A. MURRAY, JR., P.O. BOX 2188, DAVIS, CA, 95617, US

(73) Assignee: WEIDLINGER ASSOCIATES, INC., MOUNTAIN VIEW, CA (US)

(21) Appl. No.: 12/333,925

(22) Filed: Dec. 12, 2008

Related U.S. Application Data
(60) Provisional application No. 61/013,894, filed on Dec. 14, 2007.

(51) Int. Cl. B05B 1/08

(52) U.S. Cl. 239/102.2

(57) ABSTRACT

One embodiment includes a piezoelectric fuel injector using single crystal piezoelectric materials to improve the capabilities and performance of fuel injectors using a piezoelectric material stack. Another embodiment includes a fuel injector with a single crystal piezoelectric actuator stack that exceeds one or more of the capabilities (e.g., stroke, force, bandwidth, size) of the standard piezoceramic actuator stacks designed for the common rail fuel injector systems. Yet another embodiment includes an actuator stack made from single crystal piezoelectric material.

### FIELD OF THE INVENTION

The present invention relates to piezoelectric fuel injectors. More specifically, to fuel injectors with an actuator stack that exceeds the capabilities (stroke, force, bandwidth, size) of the standard piezoceramic actuator stacks designed for the common rail fuel injector systems.

### BACKGROUND

The proper operation of combustion engines requires the timed ignition of a fuel:air mixture of a given ration. The quantity of fuel injected into the engine cylinders at any time is controlled by the fuel injector system. Fuel injection systems are preferred over carburetors as fuel delivery systems because fuel injection systems can reduce the fuel:air ratio variability, reduce stalling and engine run-on, and reduce throttle-change lag. Furthermore, fuel injection systems can be matched to specific requirements (e.g. power, economy, emission reduction).

Fuel injection systems control the timing of fuel entry into the engine cylinders. Typically, fuel is supplied from a fuel pump into the top of an injector. The fuel is blocked from injection by nozzles, and an actuator is responsible for opening and closing the nozzle. Under electronic control, pulse of fuel will allow for limited control of fuel:air timing. The capacity for greater control of fuel injection will improve fuel efficiency, increase engine power, reduce engine emissions, and reduce engine noise.

Fuel injectors typically include an actuator such as a piezoceramic stack actuator or an electromagnetic solenoid actuator. The piezoceramic stack actuator is preferable to electromagnetic solenoid actuators because electromagnetic solenoid actuators are digital on/off devices. This means that there is no control of the flow rate. In contrast to solenoid actuators, using a piezoceramic stack actuator allows for faster response time, linear-analog response. Further, piezoceramic stack actuators are also typically smaller and lighter.

Piezoelectricity, or the piezoelectric effect is the ability to generate an electrical charge upon straining a material (usually a crystal or ceramic). Piezoelectric materials are ideal for use in actuators, since an introduction of high voltage will only correspond to limited changes in the shape of the piezoelectric material. This allows one to accurately construct a linear-analogous displacement system.

However, there are certain limitations to piezoceramic stack actuators. Due to the limits in the poling of piezoceramics during manufacture, and the practicality of extremely high voltages required by thick ceramics for operation, individual layers rarely exceed a few millimeters. Piezoelectric stacks also encounter difficulties when operating in tension. This sometimes will lead to a failure of the device due to the debonding of layers.

### SUMMARY

Engines using piezoelectric actuator technology will be able to operate at higher pressures, with improved fuel efficiency and performance, and at lower cost. Given a customer's requirements for gasoline, diesel, and other fuels, the cost reductions in improved fuel efficiency could be significant.

One embodiment includes an apparatus comprising a piezoelectric material stack, said piezoelectric material stack comprising one or more layers of piezoelectric single crystals. Optionally, the apparatus further includes a fuel injector, wherein the piezoelectric stack is contained within the fuel injector.

Another embodiment includes a piezoelectric fuel injector comprising a high pressure port for providing fuel; a fuel return coupled to the high pressure port; a valve coupled between the high pressure port and the fuel return; a hydraulic amplifier for activating the valve; and a single crystal piezoelectric actuator stack coupled to the hydraulic amplifier. Optionally, the embodiment further includes a nozzle needle coupled to the valve; and an injection orifice for providing fuel injection.

Yet another embodiment includes an actuator stack for a fuel injector comprising a plurality of layers of piezoelectric material, wherein each layer comprises a single crystal piezoelectric material. Optionally included in some embodiments is a voltage source coupled to each of the plurality of layers of piezoelectric material; and an electrical ground coupled to each of the plurality of layers of piezoelectric material.

Still yet another embodiment is an apparatus comprising a piezoelectric material stack, said piezoelectric material stack comprising a plurality of layers of piezoelectric material, wherein each layer comprises a single crystal piezoelectric material.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram of a piezoelectric-actuated fuel injector in accordance with one embodiment;

FIG. 2 is a diagram of a piezoelectric actuator stack in accordance with one embodiment;

FIG. 3 is a chart measuring displacement of single piezoelectric crystal versus a piezoelectric ceramic under 100V square wave excitation; and

FIG. 4 is a chart measuring the block force output of a single piezoelectric crystal versus a piezoelectric ceramic under 100V square wave excitation.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

The present embodiments improve the performance and efficiency of fuel injectors based upon the large strain and high coupling properties of piezoelectric single crystals using single crystals, such as lead-magnesium-niobate-lead titanate This is an exemplary chemical formulation of the single crystal piezoelectric material, and it can be altered by the manufacturer to slightly change the properties of the material (PMN-30%PT), in the piezoelectric actuator stack. This improves engine performance, but without the need for replacement of the entire engine.

The present embodiments replace the currently used piezoceramic actuators with single crystal piezoelectric actuators to deliver greater stroke and force, with faster response times allowing for more effective control, and remove the motion amplification stages normally required due to smaller strain capability of ordinary piezoceramics.

Single crystal piezoelectric material is grown from carefully selected seeds at high temperature in a crucible. The produced single crystal is called a boule, and is cylindrical in shape. This boule is then cut into appropriate sizes for the applications. Three manufacturers in the USA exist—TRS Technologies in PA, Morgan ElectroCeramics in OH, and H.C. Materials in IL.

One embodiment includes a piezoelectric fuel injector using a single piezoelectric crystal to improve the capabilities and performance of fuel injectors using a piezoelectric material stack.

Another embodiment includes a fuel injector with a single crystal piezoelectric actuator stack that exceeds one or more of the capabilities (e.g., stroke, force, bandwidth, size) of the standard piezoceramic actuator stacks designed for the common rail fuel injector systems.

Yet another embodiment includes an actuator stack made from single crystal piezoelectric material.

Piezoelectric single crystals used in multi-layer stack actuators offer significantly higher stroke, higher block force despite lower Young's modulus, offers higher bandwidth, and possibly lowers hysteresis. It is ideal to address the shortcomings evident in ordinary piezoceramics in piezoelectric stack actuators.

Using single crystal materials instead of ordinary ceramics provides for a higher electro-mechanical coupling efficiency, a measure of the ability of the material to convert energy from electrical to mechanical or vice versa. A higher electromechanical coupling efficiency typically results in improved device bandwidth.

Specifically, single crystal piezoelectric fuel injector actuators offer maximum strains around 1% in single crystal piezoelectrics, versus 0.1% maximum strain in piezoceramics. In terms of block force, while the Young's modulus of single crystal piezoelectrics is around 50% of the ordinary ceramics, the increased piezoelectric longitudinal constant compensates for this, giving an increased maximum force of between a factor of 1.5 and 5 when compared to an ordinary piezoceramic actuator stack. In terms of electromechanical coupling efficiency, the typical piezoceramic has an efficiency around 0.75, whereas single crystal piezoelectric material has an efficiency value of 0.94.

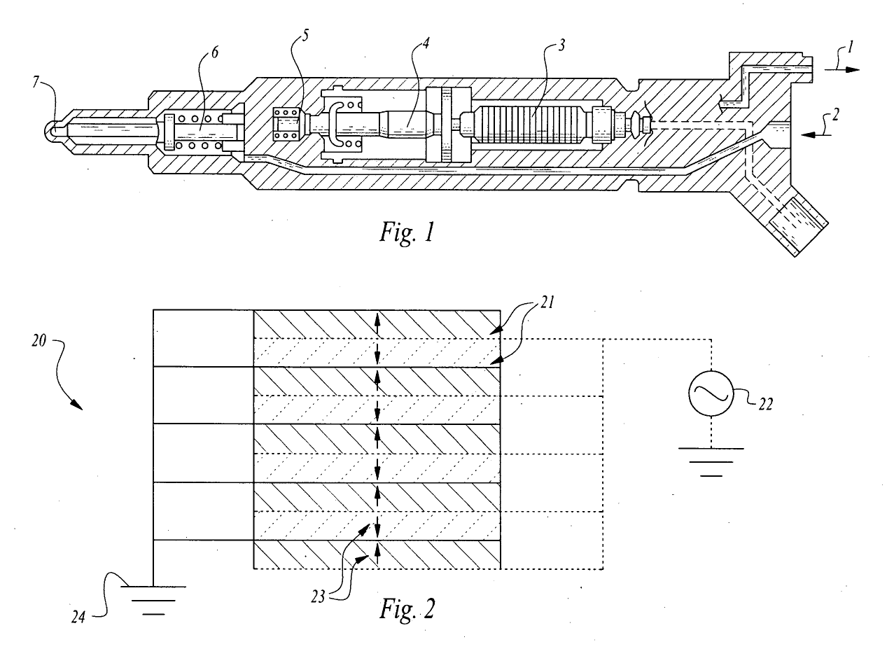

Referring to FIG. 1, shown is a piezoelectric fuel injector 10 with a single crystal piezoelectric actuator stack 3. Show in the figure is a fuel return 1, a high pressure port 2, a hydraulic amplifier 4, a valve 5, a nozzle needle 6 and an injection orifice 7.

The nozzle needle 6 is connected to the injection orifice 7. Nozzle needle 6 is also connected to valve 5. Valve 5 is connected between nozzle needle 6 and hydraulic amplifier 4. The hydraulic amplifier 4 is connected between piezoelectric actuator stack 3 and valve 5. Valve 5 is also connected to high pressure port 2 and fuel return 1 to allow fuel to flow through valve 5 and to nozzle needle 6 and injection orifice 7.

The fuel injector 10 receives fuel from the high pressure port 2. Fuel from the high pressure port 2 runs through the value and exits through the fuel return 1. The fuel received by fuel injector 10 is constrained by release by the valve 5. The single crystal piezoelectric actuator stack 3 is controlled by an external power source. Upon being stimulated by an electrical signal, the single crystal piezoelectric actuator stack 3 will deform and causing displacement in size, which will activate the hydraulic amplifier 4. The nozzle needle 6 and the injection orifice 7 atomize the fuel when the valve 5 is opened to allow fuel injection.

The piezoelectric stack 3 activates fuel injection hydraulically, ensuring that it is mechanically isolated from the nozzle needle 6 to protect it from extremes of pressure and temperature. The hydraulic amplifier 4 is used to ensure sufficient pressure to operate the nozzle needle 7.

In one embodiment, the single crystal piezoelectric actuator stack 3, by providing improved actuator performance control of fuel:air delivery, reduces the size of, or altogether eliminates the need for the hydraulic amplifier 4. The results in smaller, less expensive fuel injectors.

FIG. 2 is a diagram of a piezoelectric actuator stack 20. In various embodiments, the piezoelectric actuator stack 20 corresponds to the single crystal piezoelectric actuator stack 3 shown in FIG. 1. The actuator stack 20 includes layers of a piezoelectric material 21. Each layer of the piezoelectric material 21 is made from a single crystal of piezoelectric material. Each layer of piezoelectric material 21 has a poling direction 23, a voltage source 22 and an electrical ground 24. The layers of piezoelectric materials 21 are identical or similar sizes and are stacked on top of each other. The layers of piezoelectric materials 21 are also connected to both voltage source 22 and electrical ground 24.

In one embodiment of the invention, voltage source 22 is coupled to every pair of layers of piezoelectric material 21 in the piezoelectric actuator stack 20. The electrical ground 24 is coupled to alternating pair of layers of piezoelectric material 21.

Typically, the piezoelectric materials 21 are aligned according to polarity and are stacked according to the poling direction 23. Single crystal piezoelectric materials, such as PMN-30%PT, has properties that vary with angle so the orientation must be appropriate for a single crystal piezoelectric actuator stack. The electrical stimulation is driven by the voltage source 22 and the electrical ground 24.

In one embodiment, the single crystal piezoelectric actuator stack 20 is placed under a compressive load within a housing to ensure the stack remains in compression even under the strongest forces.

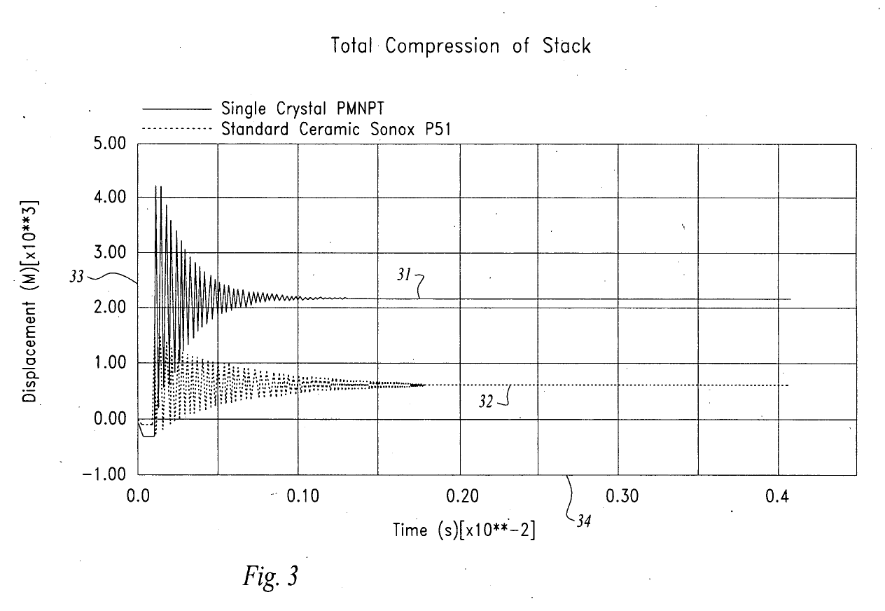

FIG. 3 depicts a displacement of a single crystal piezoelectric 31 against a displacement of a ceramic piezoelectric 32 under 100V square wave excitation. There is a horizontal axis 34 representing time in microseconds and a vertical axis 33 representing displacement in microns.

FIG. 3 demonstrates two important aspects of single crystal piezoelectrics for actuator purposes—the increased strain for a given excitation, and the high bandwidth noted by the reduced ringdown time. The displacement for the ceramic piezoelectric 32 from the prestressed state is 7 microns, compared to around 25 microns for the displacement of a single crystal piezoelectric 31, for the given excitation. This is a near 250% increase in favor of the single crystal piezoelectric.

FIG. 3 also demonstrates the fast ringdown time of single crystal piezoelectric, it can reach equilibrium in around 1.25 ms, compared to 2.5 ms for ceramic piezoelectrics. This indicates increased bandwidth for single crystal piezoelectrics, which is another important consideration for fuel injector actuators. While in reality these devices would reach equilibrium with less oscillation due to active or passive control systems, viewing the ‘raw’ response of the system indicates the inherent capabilities of piezoelectric actuator stacks.

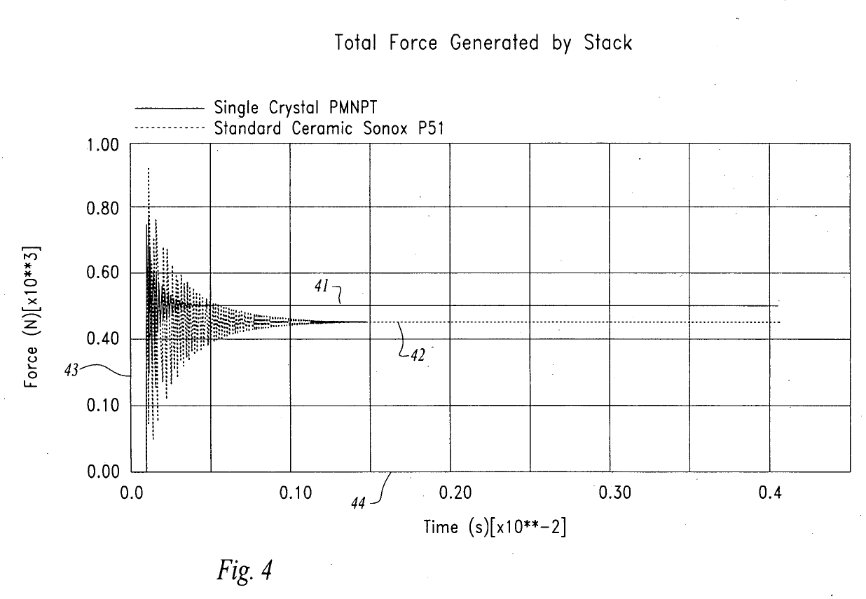

FIG. 4 depicts a block force output of a single crystal piezoelectric 41 against a block force output of a ceramic piezoelectric 42 under 100V square wave excitation. There is a horizontal axis 44 representing time in microseconds and a vertical axis 43 representing block force output in newtons.

FIG. 4 demonstrates that the block force output of single crystal piezoelectrics 41 generates 505 newtons for force, as opposed to 455 for the block force output of ceramic piezoelectrics 42, around 10% more force for the single crystal piezoelectric under those drive conditions.

FIGS. 3 and 4 are a significant simplification from the actual structure and do not account for electrode stiffness, uneven electric field due to electrode displacement, or housing/structure. However, these figures demonstrate some of the advantages of using single crystal piezoelectrics.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. An apparatus comprising:
a piezoelectric material stack, said piezoelectric material stack comprising one or more layers of piezoelectric single crystals.

2. The apparatus of claim 1 further comprising:
a fuel injector, wherein the piezoelectric material stack is contained within the fuel injector.

3. A piezoelectric fuel injector comprising:
a high pressure port for providing fuel;
a fuel return coupled to the high pressure port;
a valve coupled between the high pressure port and the fuel return;
a hydraulic amplifier for activating the valve; and
a single crystal piezoelectric actuator stack coupled to the hydraulic amplifier.

4. The piezoelectric fuel injector of claim 3 further comprising:
a nozzle needle coupled to the valve; and
an injection orifice for providing fuel injection.

5. An actuator stack for a fuel injector comprising:
a plurality of layers of piezoelectric material, wherein each layer comprises a single crystal piezoelectric material.

6. The actuator stack for a fuel injector of claim 5 further comprising:
a voltage source coupled to each of the plurality of layers of piezoelectric material.

7. The actuator stack for a fuel injector of claim 6 further comprising:
an electrical ground coupled to each of the plurality of layers of piezoelectric material.

8. An apparatus comprising:
a piezoelectric material stack, said piezoelectric material stack comprising:
a plurality of layers of piezoelectric material, wherein each layer comprises a single crystal piezoelectric material.

9. The apparatus of claim 8 further comprising:
a fuel injector, wherein the piezoelectric material stack is contained within the fuel injector.

10. The actuator stack for a fuel injector of claim 9 further comprising:
a voltage source coupled to each of the plurality of layers of piezoelectric material.

11. The actuator stack for a fuel injector of claim 10 further comprising:
an electrical ground coupled to each of the plurality of layers of piezoelectric material.
